(19) United States
(12) Patent Application Publication
(10) Pub. No.: US 2015/0176103 A1
(43) Pub. Date: Jun. 25, 2015

(54) PRODUCTION OF TITANIUM DIOXIDE PIGMENTS

(71) Applicants: Zhigang Zak Fang, Salt Lake City, UT (US); Scott Middlemas, Salt Lake City, UT (US); Peng Fang, Salt Lake City, UT (US)

(72) Inventors: Zhigang Zak Fang, Salt Lake City, UT (US); Scott Middlemas, Salt Lake City, UT (US); Peng Fang, Salt Lake City, UT (US)

(21) Appl. No.: 14/369,663

(22) PCT Filed: Dec. 28, 2011
(86) PCT No.: PCT/US2011/067583

§ 371 Date: Nov. 10, 2014

(51) Int. Cl. C22B 34/12; C01G 23/047; C22B 3/44; C22B 3/22; C22B 1/02; C22B 3/10

(52) U.S. Cl. CPC C22B 34/1245; C22B 1/02; C22B 3/10; C22B 3/44; C22B 3/22; C01G 23/047

(57) ABSTRACT

A process includes roasting a TiO₂-containing material in the presence of an alkaline material to form a roasted product; leaching the roasted product with an acidic solution to form a leach liquor; extracting the leach liquor with an extractant to form a raffinate including a Ti⁴⁺ species; hydrolyzing the Ti⁴⁺ species to form a hydrolyzed material that includes H₂TiO₃; calcining the hydrolyzed material; and recovering a TiO₂ product.

### FIELD

The present technology generally relates to the production of TiO₂.

### BACKGROUND

Titanium dioxide (TiO₂) is widely used as a pigment in paints, ointments, toothpaste, sunscreen, and many other industrial applications. In more recent years, the applications of TiO₂ have expanded, and are still expanding, in photovoltaic power generation, photocatalytic splitting of water for hydrogen production, and in many other biomedical and electronic technology areas.

To meet the market needs for TiO₂, thousands of tons are produced worldwide on an annual basis using environmentally-unfriendly production processes. Conventionally, TiO₂ is produced from either ilmenite, titania slag, or synthetic rutile, using either the sulfate process or the chloride process. See FIG. 1. Ilmenite is a mineral containing both titanium-iron oxide (FeTiO₃), and is black or grey in appearance. Titania slag is a titanium-rich material produced as a by-product of the coke smelting processes used to reduce iron oxides to liquid iron in large electric arc furnaces. Synthetic rutile is a tetragonal polymorph of TiO₂, and is nearly transparent in appearance.

The sulfate process produces TiO₂ from ilmenite using concentrated sulfuric acid in batch or continuous digestion reactors, as illustrated by the following reaction sequence:

TiO₂+H₂SO₄→TiOSO₄+H₂O

FeTiO₃+2H₂SO₄+5H₂O→FeSO₄.7H₂O+TiOSO₄

TiOSO₄+2H₂O→TiO(OH)₂+H₂SO₄

TiO(OH)₂→TiO₂+H₂O

The sulfate process produces large volumes of acidic liquid wastes, and consumes a large amount of energy in multi-step batch purification processes. Due to the waste and energy consumption, the chloride process is the commercially more dominant process.

The chloride process (see FIG. 2) was first developed more than 50 years ago by DuPont in late 1950s. The chloride process relies on chlorination and oxidation of either mineral or synthetic rutile, at extremely high temperatures (1300 to 1800° C.). In the first stage of the chloride process, CO₂ is released with the conversion of TiO₂ in the titania slag into TiCl₄, according to the following reaction sequence:

TiO₂+2Cl₂+C→TiCl₄+CO₂

2FeTiO₃+3C+7Cl₂→2TiCl₄+2FeCl₃+3CO₂

TiCl₄+O₂→TiO₂+2Cl₂

The stoichiometric reaction suggests that there will be 1 mol CO₂ released for every 1 mol TiO₂ produced by the chloride process. With the total world production of TiO₂ at approximately more than 4 million tons per year (Sahu, K. K.; Alex, T. C.; Mishra, D.; Agrawal, A. Waste Management & Research, 2006, 24, 74), and with 60% of that made by the chloride process, the total CO₂ emission attributable to this process is approximately 13.7 million tons per year. Total CO₂ emissions for both the chloride and sulfate processes is in excess of 21 million tons per year.

In addition to the sulfate and chloride commercial processes, other processes are known, including a hydrometallurgical process by Altair Nanomaterials, Inc in U.S. Pat. Nos. 6,375,923 and 6,548,039 (i.e., The Altair process). The Altair process involves digestion of titanium-containing ores using concentrated hydrochloric acid followed by multiple steps of leaching, reduction, crystallization, solvent-extraction, hydrolysis, and calcination. The advantages of the Altair process over that of conventional chloride or sulfate processes, are that it does not require extremely high temperatures, nor does it produce large volumes of acidic liquid waste. However, the Altair process involves many processing steps, and the primary reaction involves the chlorination of TiO₂, and subsequent re-oxidation of titanium to produce the TiO₂. Thus, the Altair process is an energy-intensive process.

### SUMMARY

In a first aspect, a process is provided including roasting a TiO₂-containing material in the presence of an alkaline material to form a roasted product; leaching the roasted product to form a leach liquor, extracting the leach liquor with an extractant to form a raffinate that includes Ti⁴⁺ species; hydrolyzing the Ti⁴⁺ species to form a hydrolyzed material including H₂TiO₃; calcining the hydrolyzed material; and recovering a TiO₂ product. In one embodiment, the TiO₂-containing material is synthetic rutile, mineral rutile, or TiO₂ slag. In some embodiments, the extractant includes an alkyl phosphoric acid, an alkyl phosphonic acid, an alkyl phosphinic acid, a thioalkyl phosphinic acid, a phosphate, a phosphine oxide, a primary amine, a second amine, a tertiary amine, a quaternary ammonium salt, or an ion exchange resin. In some embodiments, the extractant includes a trioctyl/decyl amine.

In some embodiments of any of the above processes, the alkaline material is an alkaline hydroxide, an alkaline oxide, or a mixture of any two or more such materials. In other embodiments of any of the above processes, the alkaline hydroxide is sodium hydroxide or potassium hydroxide, or a mixture thereof. In yet further embodiments of any of the above processes, the alkaline oxide is sodium oxide or potassium oxide, or a mixture thereof.

In some embodiments of any of the above processes, the acidic solution has chloride content. For example, the acidic solution may include HCl, CaCl₂, NaCl or a mixture thereof.

In some embodiments of any of the above processes, the roasting is carried out a temperature of at least about 500° C. In some such embodiments, the roasting is carried out a temperature of at least about 650° C. In some such embodiments, the roasting is carried out a temperature of at least about 700° C. In some embodiments, the roasting is carried out at a temperature of from about 500° C. to about 2000° C.

In any of the above methods, the roasted product comprises one or more of Na₂Fe₂TiO₆ and Na₂TiO₃; and one or more impurities.

In some embodiments of any of the above processes, the calcining is conducted at a temperature from about 500° C. to about 1000° C. In some embodiments of any of the above processes, the calcining is conducted at a temperature from about 500° C. to about 800° C. In some embodiments of any of the above processes, the calcining is conducted at a temperature from about 500° C. to about 650° C. In other embodiments, the calcining is conducted at a temperature of about 650° C. In one particular embodiment, the calcining is conducted at a temperature of about 650° C. to about 1000° C.

The TiO₂ product produced by any of the above processes may include pigment-grade TiO₂, rutile TiO₂, anatase TiO₂, or pigment-grade, anatase TiO₂. Such TiO₂ products contain less than 50 ppm of Fe. For example, the TiO₂ products may contain less than 10 ppm of Fe.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flow-chart illustration of the sulfate and chloride processes.

FIG. 2 is a flow-chart illustration of the chloride process.

FIG. 3 is a flow-chart illustration of a process for TiO₂ production, according to some embodiments.

FIG. 4 is a flow-chart illustration of chemical sequential treatments and extractions during a process for TiO₂ production, according to some embodiments.

FIG. 5 is a flow-chart illustration of a process for TiO₂ production, according to some embodiments.

FIG. 6 is an XRD profile of a TiO₂ sample after roasting, acid leaching, and calcination, according to various embodiments.

FIG. 7 is a graph of the Gibbs free energy of reactions of silica, and other silicates, in titania slag with sodium hydroxide, as a function of temperature, according to various embodiments.

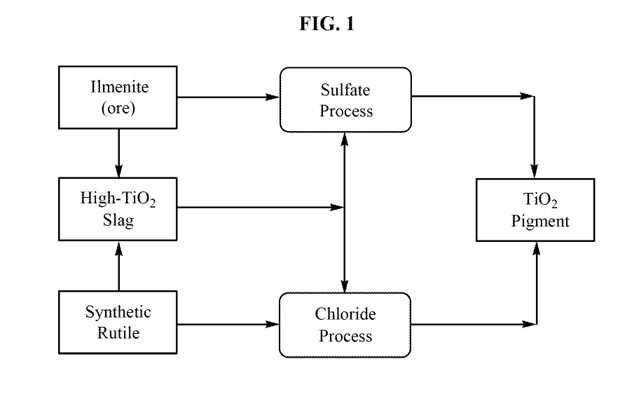

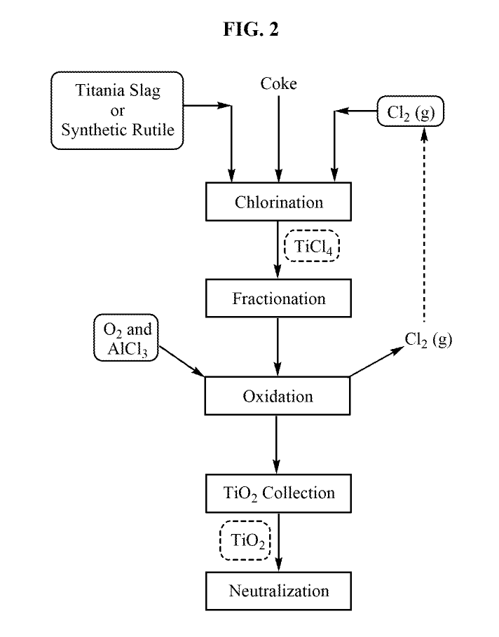

### DETAILED DESCRIPTION

In one aspect, a process is provided for preparing TiO₂ in a manner that is more environmentally friendly than conventional processes. For example, the process minimizes, or eliminates CO₂ emissions during TiO₂ production, and reduces overall energy consumption by up to 50%. The method also recycles and regenerates chemical reagents used in the process, thus substantially reducing the amount of environmental waste generated by the process. The process differs from conventional metallurgical methods by utilizing chemical sequential extraction methodologies to remove impurities in the titania ores. Such impurities may include, but are not limited to, silicate, silicate-containing, iron, or iron-containing species.

According to one embodiment, the process includes producing pigment-grade TiO₂ from high-TiO₂ content slag; using an integrated chemical sequential treatment and extraction processes. As used herein, the phrase “chemical sequential extraction” refers to a series of thermal treatments and chemical reagents that are sequentially applied to a solid mixture of a roasted titania slag to achieve metal fractionation. The treatments, the reagents or extractants, the number of stages, and the order by which they are applied depend on the characteristics of the solid mixture.

As used herein, the term “pigment-grade TiO₂” refers a material that is not less than 93% pure. However, according to various embodiments, the pigment-grade TiO₂ is not less than 94% pure, not less than 95% pure, not less than 96% pure, not less than 97% pure, not less than 98% pure, or not less than 99% pure. In some embodiments, pigment-grade TiO₂ is defined as being not less than 99.5% pure. As used herein, high-TiO₂ content slag refers to titania slag containing from about 70% to about 90% titania.

According to one embodiment, the process sequence, from raw materials to final pigments, is illustrated in FIG. 3. It can be seen that there are two processing steps using either high-TiO₂ slag or synthetic, or mineral rutile as the feed material. The two key processing steps are: (1) an alkaline hydroxide roasting process involving reactions of the raw material with alkaline hydroxides; and (2) a chemical sequential extraction process (e.g. leaching and solvent extraction) for removing silicon, iron, and other impurities from the material to produce the pigment-grade TiO₂. According to some such embodiments, the process may begin with either an ilmenite ore that is converted to a TiO₂-rich slag, or from synthetic rutile. Either of these starting, TiO₂-containing materials, or a mixture thereof, is subjected to alkaline hydroxide roasting. The products of the roasting are then further processed through leaching and extraction to afford the pigment-grade TiO₂.

The alkaline hydroxide roasting process chemically separates the titanium dioxide from impurities in the TiO₂-containing starting materials and forms silicates, iron oxides (i.e., iron(II)), elemental iron, and other compounds such that they may be leached in the subsequent processing steps. Impurities in the TiO₂-containing starting materials include iron oxides, silica, and other impurities. In the process, the impurities react with alkaline materials such as an alkaline hydroxide, alkaline alkoxide, or alkaline oxide. Such materials include, but are limited to sodium hydroxide, potassium hydroxide, sodium methoxide, sodium ethoxide, sodium tertiary-butoxide, potassium methoxide, potassium ethoxide, potassium tertiary-butoxide, sodium oxide, potassium oxide, calcium hydroxide, magnesium hydroxide, calcium oxide, magnesium oxide, and mixtures of any two or more such bases. Without being bound by theory, it is believed that in the alkaline hydroxide roasting process, the chemical separation of titanium from iron oxides and other impurities is accomplished according to the following reactions:

FeTiO₃+2NaOH→Na₂TiO₃+FeO+H₂O

TiO₂+2NaOH→Na₂TiO₃+H₂O

By forming Na₂TiO₃, a Ti⁴⁺ species, the titanium is chemically separated from the iron oxides and other impurities, and it can later be subjected to reaction with an acid to form H₂TiO₃. The H₂TiO₃, when calcined, is converted to TiO₂. Thus, the series of reactions that transforms the material to TiO₂ are:

Na₂TiO₃+2HCl→H₂TiO₃+2NaCl

H₂TiO₃→TiO₂+H₂O

Neither Na₂TiO₃ or H₂TiO₃ are soluble in water, and H₂TiO₃ is not soluble in HCl solution. Prior to hydrolysis to form H₂TiO₃, impurities are removed from the mixture using an aqueous extractant. In the above, reactions, NaOH is illustrated as an alkaline material for illustrating stoichiometric ratios, however, those of skill in the art will readily understand proper stoichiometric ratios for other alkaline materials.

As described above, the roasting also prepares the impurities for the leaching process. Impurities in TiO₂ slag typically include, but are not limited to, oxides of iron, silicon, aluminum, calcium, magnesium, chromium, vanadium, etc. Again, without being bound by theory, it is believed that the reactions responsible for the impurity removal using NaOH include:

SiO₂+2NaOH→Na₂SiO₃+H₂O

Al₂O₃+2NaOH→2NaAlO₃+H₂O

2TiO₂+4FeO+O₂+4NaOH→2Na₂Fe₂TiO₆+2H₂O

4FeO+O₂+2SiO₂+4NaOH→2Na₂Fe₂SiO₆+2H₂O

CaO and MgO may also form silicates (MSiO₃, where M=Ca or Mg) with SiO₂, or aluminates (MAl₂O₄) with Al₂O₃. Silicates can be categorized as glassy or crystalline phases. Glass phase silicates are usually the product of melting and relatively fast cooling. Crystalline silicates may further vary in characteristics with respect to their acidity or base characteristics depending on the molar ratios between alkaline elements and SiO₃²⁻. Typically, glass silicates are undesirable because they are resistant to leaching in alkaline solutions. Acidic silicates are also difficult to leach. Therefore, controlling the roasting process aids in preventing the formation of refractory silicates that are difficult to leach in subsequent treatments. Such may be controlled by varying the NaOH:slag ratio, and the temperature.

After the roasting of the TiO₂-containing material, the roasted product is leached with an acidic solution to form a leach liquor. The acidic solution typically includes chloride content. The chloride content may be managed using a chloride containing acid, such as HCl, or by adding a chloride containing compound, such as CaCl₂ or NaCl to the acid solution. In one embodiment, the acidic solution includes HCl and CaCl₂. In another embodiment, the acidic solution includes HCl and NaCl. In some embodiments, the concentration of the acid is from about 4M to about 12M. In some specific embodiments, the concentration of the acid is from about 4M to about 7M. In some embodiments, a calculated amount of NaCl or CaCl₂ is added to bring total chloride content to higher concentrations without changing the acid concentration. For example, 1.5M CaCl₂ may be added to 4M HCl to provide for a total chloride content of 7M.

The leach liquor, is then extracted with an extractant, thereby leaving a raffinate that includes at least one Ti⁴⁺ species. Suitable extractants for the extraction of the leach liquor include, but are not limited to, aqueous solutions of an alkyl phosphoric acid, an alkyl phosphonic acid, an alkyl phosphinic acid, a thioalkyl phosphinic acid, a phosphate, a phosphine oxide, a primary amine, a second amine, a tertiary amine, a quaternary ammonium salt, or an ion exchange resin. For example, the extractant may include, but is not limited to, di(2-ethylhexyl)phosphoric acid; 2-ethylhexyl phosphonic acid mono-2-ethylhexyl phosphoric ester; di-2,4,4-trimethylpentyl phosphinic acid; di-2,4,4-trimethylpentyl monothiophosphinic acid; di-2,4,4-trimethylpentyl dithiophosphinic acid; a phosphate of formula (O)P(OR¹)₃; a phosphine oxide of formula (O)PR²₃ or (O)PR³₂R⁴; trioctyl amine; or trioctyl methyl ammonium chloride; quaternary amine; wherein R¹, R², R³, and R⁴ are individually C4-C10 alkyl. Such materials may be in an aqueous solution. In one embodiment, the extractant includes a tertiary amine which is a trialkylamine and each alkyl group of the trialkylamine is independently a C₆-C₁₈ alkyl. In one embodiment, the extractant includes a tertiary amine which is a trialkylamine and each alkyl group of the trialkylamine is independently a C₈-C₁₂ alkyl. In one specific embodiment, the extractant includes a trioctyl/decyl amine, such as that which is commercially available as Alamine® 336, from Cognis Corporation.

With respect to the ability to leach the impurities from the product of the roasting, the roasting temperature is a parameter that may be modified. Excessively high temperatures tend to lead to formation of a hard cake that is unsuitable for subsequent acid-, alkaline-, or water-leaching methods. Further, in conventional roasting methods, the roasting is conducted in air to oxidize FeO to Fe₂O₃. However, the Fe₂O₃ produced is resistant to acid- or alkaline-leaching. Therefore, the present processes provide a pathway in which the iron is maintained in the form of FeO, prior to the leaching. This may be accomplished by performing the roasting under a reducing atmosphere, as opposed to conducting the roasting in air. Thus, in some embodiments, the roasting temperature is at least about 500° C. In some embodiments, the roasting temperature is greater than about 700° C. In other embodiments, the roasting temperature is from about 700° C. to about 1000° C. In yet other embodiments, the roasting temperature is from about 650° C. to about 800° C. In some embodiments, a roasting temperature below about 800° C. is desired to prevent liquid formation of the roasted materials which can result in a condensed cake that is kinetically unfavorable for subsequent leaching processes. Roasting can be performed from 30 minutes to 4 hours, depending on the particular embodiment. In one embodiment, the roasting is performed for about 1 hour.

According to some embodiments, the optional reducing atmosphere is one containing a gas such as hydrogen (H₂), carbon monoxide (CO), water vapor, or a mixture of any two or more such gases.

From the possible reactions as mentioned above, it can be seen that the reactions involved in roasting are complex. A number of adverse reactions during roasting may occur to form complex salts and oxides, which are resistant to leaching. Thus, synthetic compositions of feedstock materials (i.e., TiO₂; SiO₂; FeO; NaOH) may be varied to determine the optimal composition for a particular reaction, or set of conditions. The cake prepared from such roasting may be tested in acid and/or alkaline solutions to determine the impurity leach-ability and to optimize the roasting conditions.

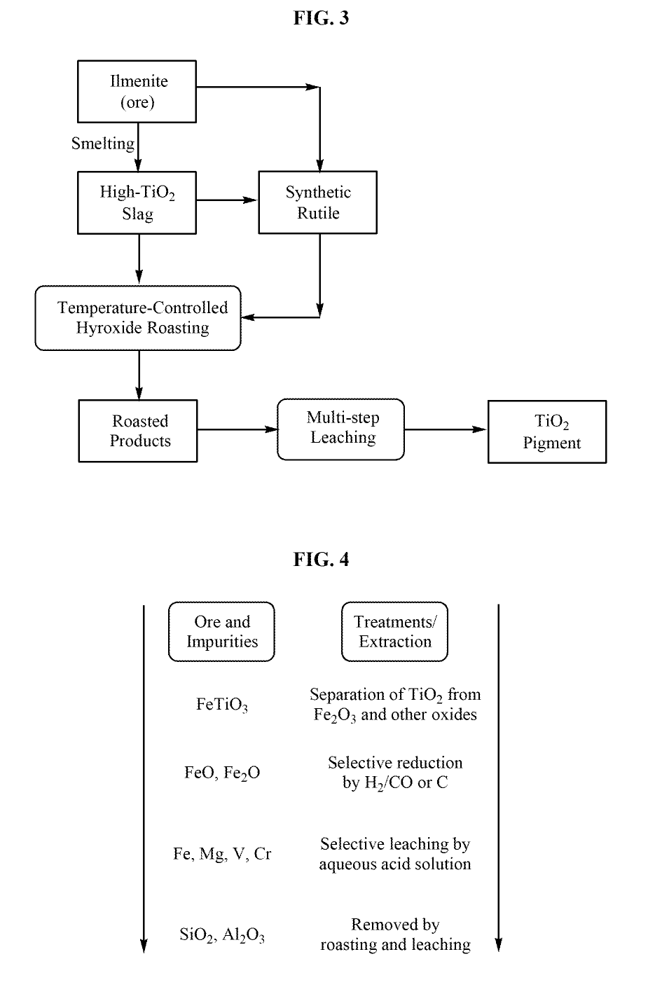

Specifically, for the purification of TiO₂ with impurities, a sequential treatment scheme is illustrated in FIG. 4. In FIG. 4, the impurities contained in the material after roasting are grouped into those that are may be leached by acid solution, alkaline solution, or water. For example, impurities that are readily reducible in the reducing atmosphere, include FeO and Fe₂O₃, elemental impurities that are soluble in aqueous acid solutions include Fe, Mg, V, and Cr; and impurities that are soluble in alkaline solution include SiO₂, Al₂O₃. Based on the properties of the impurities, sequential leaching steps may be applied to remove such impurities. Because the material has been subjected to the alkaline roasting process that is designed to leave these species in a condition that makes them amenable to leaching, the sequential extraction processes purify the material sufficiently to meet the requirements of pigment-grade TiO₂. For example, iron, an impurity that is typically present in TiO₂ production, may be reduced in the final product to less than about 0.05%, in some embodiments. In other embodiments, the iron content in the pigment-grade TiO₂ is less than about 0.10%, less than 0.05%, or less than 0.01%. In other embodiments, the iron content in the pigment-grade TiO₂ is from about 0.0001% to about 0.05%, from about 0.005% to about 0.05%, or from about 0.001% to about 0.01%.

Thus, according to some embodiments, the process includes roasting a TiO₂-containing material in the presence of an alkaline material, and, optionally, a reducing atmosphere to form a roasted product; leaching the roasted product with an acid to form a leach liquor; extracting the leach liquor with an extractant to form a raffinate that includes a Ti⁴⁺ species; hydrolyzing the Ti⁴⁺ to form a hydrolyzed material that includes H₂TiO₃; calcining the hydrolyzed material; and recovering a TiO₂ product. In some embodiments, the calcining is conducted at a temperature from about 500° C. to about 1000° C., or from about 500° C. to about 800° C., or from about 500° C. to about 650° C. In other embodiments, the calcining is conducted at a temperature of about 650° C.

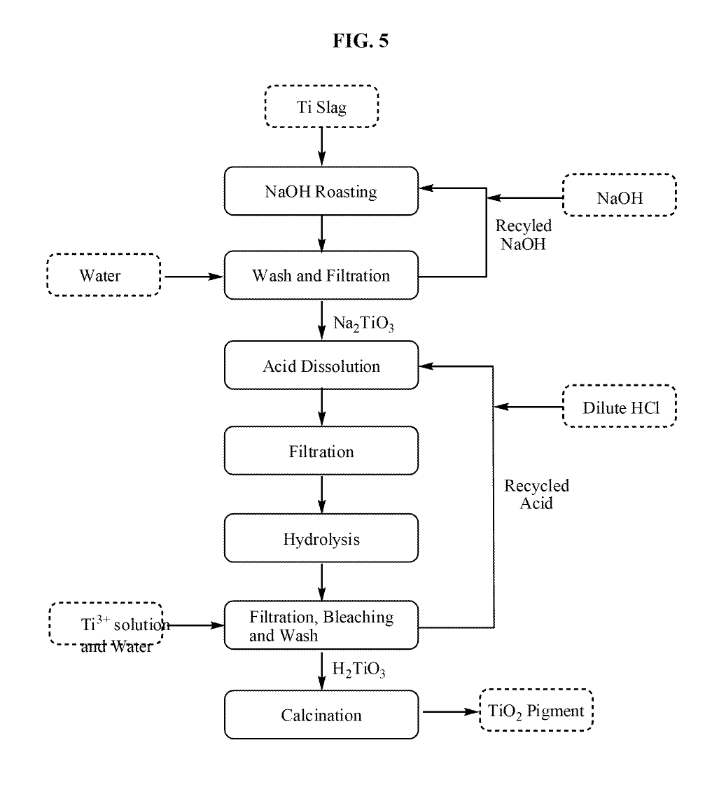

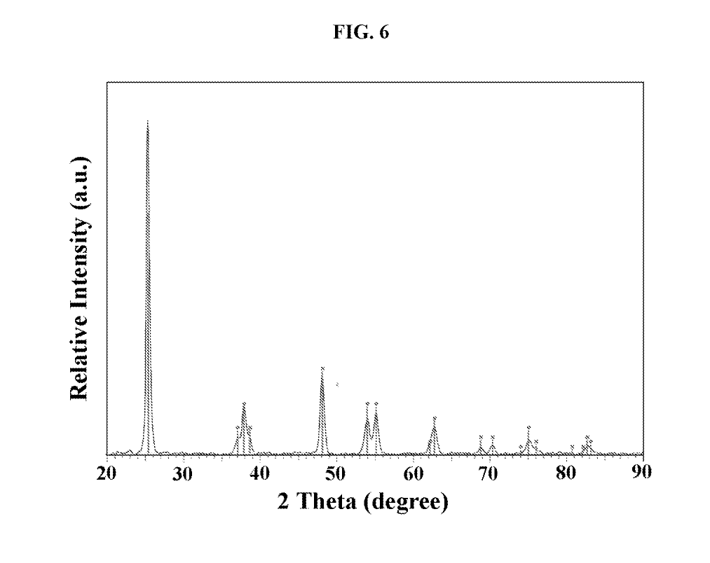

An overall process chart, according to some embodiments, for the production of pigment-grade TiO₂ is shown in FIG. 5.

In comparison to the chloride process for TiO₂ production, the above processes drastically reduce CO₂ emissions, reduce energy consumption, and are on par with the chloride process in terms of cost. Furthermore, the above processes minimize the environmental impact by reducing waste streams, such as those from liquid acidic wastes that are a part of both the sulfate and chloride processes. This is achieved by recycling, and regenerating, the acids and alkaline materials that are used.

Thus, in another aspect, the process includes treating and recycling the acids and alkaline materials used. According to some embodiments, the net effect of the regeneration and recycling is that the entire production of the TiO₂, is a near-zero waste process.

In general, metallurgical industries typically discharge waste solutions to the environment after neutralization, mixing with lime or acid, depending on the pH of the waste solution, and assuming that any salt or toxins are at, or below, permissible levels. In comparison, in the present process the waste solutions may contain low concentrations of salts, such as sodium chloride, from the acid and alkaline leaching steps. The waste solutions may then be neutralized with acid, and the resulting salts concentrated using membrane technologies to produce a concentrated salt waste solution. If the salt is sodium chloride, electrolytic techniques may be combined with the TiO₂ production, to produce HCl and NaOH from the waste stream, for recovery and re-use in the process.

Without being bound by theory, regeneration of HCl and NaOH, using electrolysis of the waste NaCl aqueous solutions includes the following reactions:

Anode half cell reaction for production of chlorine: 2NaCl−2e⁻→Cl₂+2Na⁺

Cathode half cell reaction for production of hydrogen: 2H₂O+2e⁻→H₂+20H⁻

Chlorine and hydrogen form HCl in gas phase: Cl₂+H₂→HCl

HCl is then adsorbed by water to produce industrial grade hydrochloride acid. In the aqueous phase, Na⁺ and OH⁻ combine to form NaOH, which may then be recycled in the process.

Regarding the separation and removal of impurities from the waste solution, if the acid and alkaline leach solutions are neutralized before entering electrolysis system, the impurities may be at least partially removed from the aqueous phase by adjusting the pH of the solution. For example, Fe(II), ARM), Cr(III), Cu(II), Ca(II), and Mg(II) will precipitate out as hydroxide species, and Si(IV) will be converted to SiO₂. It is expected that a small amount of the impurities may remain in electrolytic solution.

As described above, production of TiO₂ via the present process does not result in the direct emission of CO₂. Carbon dioxide emission is possible, however, if the roasting and calcinations processes use the heat from the burning of coal. In other words, if coal is chosen as the energy source for the two steps as described, the amount of carbon that is required would be 0.442 mol for every 1 mol of TiO₂ produced, based on the estimated energy consumption of the process and the heat released from carbon combustion. In comparison to the chloride process, the embodiments described herein result in at least about a 50% reduction in CO₂ emissions. Of course, the CO₂ emission is completely eliminated if a renewable energy or nuclear-generated energy is used for heating the furnaces during the roasting and calcination steps. By replacing the current commercial processes, the described process for the production of pigment grade TiO₂, has the potential to reduce the CO₂ gas emissions by more than 10 million tons per year.

Compared to the chloride process, a substantial energy reduction may also be realized by using the described process. This is because the described process does not have high temperature requirements, such as the oxidation of TiCl₄ during the chloride process. This is a direct result of not having to break Ti—O bonds during production.

The most energy-intensive steps of the described process are: the alkaline roasting, and the calcination steps. In order to compare the energy efficiency to that of the chloride process, approximate energy balance calculations were conducted. The results show that the energy consumption for producing 1 kg TiO₂ by the described process is approximately 2000 kJ (e.g. including, 1626 kJ for NaOH roasting, and 375 kJ for H₂TiO₃ calcination respectively). Assuming that the above two steps consume 80% of total energy of the whole process, and the energy use efficiency is 50%, the total energy consumption of the proposed process can be estimated to be roughly 5000 kJ for producing 1 kg TiO₂ pigment.

In comparison, based on a published documentation of industrial practice by Brown and co-workers, the energy consumption for producing 1 kg TiO₂ pigment via the chloride process is 10300 kJ. See Brown, H. L.; Hamel, B. B.; Hedman, B. A. Energy Analysis of 108 Industrial Processes, Fairman Press, 1985, p.115. This estimate for the chloride process only takes into account the five major energy-consuming steps: chlorination, TiCl₄ vaporization, O₂ heating, TiCl₄ oxidation and TiO₂ calcination. The comparison suggests that the described process represents an approximately 50% reduction in energy consumption. Assuming that 60% of the 4 million ton per year global production of TiO₂ pigment is conducted using the chloride process, full replacement of the chloride process by the described process will result in an energy consumption reduction of 0.012 trillion Btu/year for the production of pigment grade TiO₂.

The last step of the described process is to recycle and regenerate NaOH and HCl from the solutions after the leaching. By doing so, the process is a near-zero discharge process, thus having a considerable advantage with respect to the sulfate process that is still used in many parts of the world.

### Examples

Studies have been conducted to illustrate individual reaction steps in the process. Such individual steps include the reaction of the sodium hydroxide with TiO₂, and/or FeTiO₃, to form NaTiO₃; the reaction of sodium hydroxide with a silicon species; and the reaction of crystalline silicates during alkaline leaching. Materials such as FeTiO₃ and sodium hydroxide were purchased from Sigma Aldrich. Alamine® 336 is a water insoluble, tri-octyl/decyl amine which is capable of forming oil soluble salts of anionic species at low pH, and is commercially available from Cognis Chemicals. The following examples are illustrative various embodiments, and are not intended to be limiting.

### Example 1

Reaction of NaOH with titania slag to form Na₂TiO₃. A 20 g mixture of slag and NaOH (molar ratio of 1:3) was prepared in a tumbler mixer. The mixture was heated to 500° C. and held at that temperature for 4 hours to form a roasted product. The roasted product was collected and washed with water. The washed, roasted product is then leached with a various aqueous HCl solutions as set forth below to produce a first liquor containing soluble materials, including, Ti⁴⁺, Fe²⁺, and Fe³⁺ materials. The first liquor is then extracted with an extractant such as Alamine® 336, to produce a raffinate that is reduced in Fe content as compared to the first liquor. The raffinate is then hydrolyzed and bleached to form a solid material containing H₂TiO₃. The solid material is then collected by filtration and calcined at 650° C. for 2 hours. The presence of pure anatase TiO₂ was confirmed using by analyzing using powder x-ray diffraction (powder XRD) techniques. FIG. 6 is a powder XRD pattern for the recovered anatase TiO₂.

Leaching and Extraction Tests With HCl and Alamine® 336.

The liquor used in the solvent extraction steps was prepared by leaching the washed, roasted product described above with various concentrations of aqueous hydrochloric acid. The roasted product was leached for 3 hours at 50° C. inside a round bottomed flask placed inside a temperature-controlled oil bath. The liquid to solids ratio for each test was 10 to 1 by weight. The solution was stirred by a laboratory mixer with a polypropylene paddle. Reagent grade hydrochloric acid, at the concentrations set forth below, was used for the leaching.

The extraction, or organic phase, was prepared by dissolving the extractant (e.g. Alamine® 336) in a diluent (e.g. kerosene) and alcohol (e.g. dodecanol). The volume fractions of extractant, diluent, and alcohol were about 0.20, 0.70, and 0.10, respectively. The organic to aqueous phase (i.e. leaching liquor) ratio (O:A) was about 4:3. The leach liquor and the organic phase were mixed in a beaker on a stirring hot plate set at 300 rpm, and the solution temperature was maintained at 40-45° C. The dodecanol tended to form a third phase when it contacted the aqueous solution at temperature below its melting point (24° C.), thus a higher reaction temperature was needed for efficient mixing and separation. The phases were mixed for 20 minutes, which was considered excessive, but ensured that equilibrium had been reached. Phase separation was performed in a laboratory reparatory funnel. The phases separated relatively quickly, with a phase break forming in less than a minute.

As stated previously, the primary focus of the experiments was to investigate the ability of the Alamine® 336 extractant to remove iron from the leach liquor. Thus, fresh organic materials were used at each of the 3 contact stages, with the raffinate (the extracted liquor) being re-used from stage to stage, however some tests only had one stage. The raffinate from each stage was sampled, diluted, and examined using inductively coupled plasma-atomic emission (ICP-AES) spectroscopic analysis. The results for Tests 5-8 were verified with inductively coupled plasma-mass spectroscopy (ICP-MS) analysis as well. A constant phase ratio was maintained from stage to stage. The amount of each element extracted by the organic phase was measured by the change in concentration from the feed and the raffinate at each stage. The main variable changed in each experiment was the concentration of the HCl used in the leaching step to produce the leach liquor. The range of concentrations of HCl used in the investigation was from 1.6M (molar) to 12M.

Test 1.

The concentration of HCl used in Test 1 was 1.6M. It was observed that some low temperature precipitation of Ti had occurred during the leaching, although this was filtered out after leaching. When the leach liquor was poured into the organic solvent, a third phase almost instantaneously formed. It is believed that contacting the leach solution at this acid concentration with the organic caused the leach solution to become unstable, resulting in further precipitation of titanium. The mixture was then separated, and the raffinate was sampled for ICP analysis, which revealed that there was neglible extraction of Fe by the organic phase. As shown in Table 1, the amount of iron in the aqueous phase and in the raffinate was significant.

TABLE 1
Test 1 Extraction Results.

| | Metal (ppm) | | | | | | | |
|---|---|---|---|---|---|---|---|---|
| Test | Ti | Fe | Al | Mg | Mn | Ca | Si | Na |
| Test 1 Aq Feed | 5033 | 2823 | 184 | 1645 | 132 | 354 | 0 | 16957 |
| Test 1 Raff 1 | 265 | 2499 | 181 | 1659 | 132 | 389 | 7 | 17640 |

Test 2.

The concentration of HCl used in Test 2 was 2.4M. Test 2 provided results that were similar to Test 1.

Test 3.

The concentration of HCl used in Test 3 was 4.8M. A small amount of precipitation occurred during leaching, but the concentration of Ti in the leach liquor was still relatively high. Although no precipitation occurred during the mixing and separation of the organic and aqueous phases, the raffinate after the third stage began to get cloudy and a solid began to form after a few minutes. This premature precipitation prior to hydrolysis is generally seen as unfavorable as it creates low quality pigment in subsequent processing steps. The extent of precipitation made preparing an accurate sample for ICP analysis difficult, thus no results are provided.

Test 4.

The concentration of HCl used in Test 4 was 5.0M. No precipitation was observed to have occurred during leaching. Only one contact stage was used for Test 4. Table 2 shows that the extraction efficiency for Fe was very high in Test 4, with essentially all of the Fe being extracted in a single contact. The measured Fe level was below the detection limit of 0.001 ppm, so with a sample diluted by a factor of 1000, the Fe level was determined to be below 1 ppm. The extraction of the Fe also cause a relative increase in the concentration of the other elements slightly, except for Si, due to the removal of the Fe.

TABLE 2
Test 4 Extraction Results.

| | Metal (ppm) | | | | | | | |
|---|---|---|---|---|---|---|---|---|
| Test | Ti | Fe | Al | Mg | Mn | Ca | Si | Na |
| Test 4 Aq | 94612 | 12965 | 268 | 5580 | 79 | 1139 | 623 | 51062 |
| Feed | | | | | | | | |
| Test 4 | 105271 | 0 | 299 | 6163 | 95 | 1233 | 617 | 55291 |
| Raff 1 | | | | | | | | |

Test 5.

The concentration of HCl used in Test 5 was 8.3M. No precipitation occurred during leaching. As evidenced in Table 3, the extraction of Fe was high after a single stage, and appeared to be near completion by the third stage. Some co-extraction of Ti as well as all of the other elements was observed, although the concentrations of most elements increased by the third stage, due to the extraction of Fe and Mn.

TABLE 3
Test 5 Extraction Results.

| | Metal (ppm) | | | | | | | |
|---|---|---|---|---|---|---|---|---|
| Test | Ti | Fe | Al | Mg | Mn | Ca | Si | Na |
| Test 5 Aq Feed | 29887 | 4464 | 215 | 2370 | 228 | 476 | 0 | 6604 |
| Test 5 Raff 1 | 25143 | 9 | 144 | 2008 | 172 | 370 | 95 | 5599 |
| Test 5 Raff 3 | 31918 | 0 | 181 | 2559 | 108 | 461 | 99 | 7143 |

Test 6.

For this test, the concentration of HCl used during the leaching phase was 1.6M, but then concentrated HCl (12M) was added to the filtered leach liquor to bring to it to the same concentration as in Test 5 (8.3M). The concentrations of elements in the feed solution were much lower than in the other tests. The Fe extraction was still quite high, although it didn't appear to be as efficient as the solution from Test 5, even though it had the same acid concentration. Co-extraction of other elements, including the Ti, was observed. The measured value of Si on the ICP-MS was below the detection limit, hence it was reported as 0.

TABLE 4
Test 6 Extraction Results.

| | Metal (ppm) | | | | | | | |
|---|---|---|---|---|---|---|---|---|
| Test | Ti | Fe | Al | Mg | Mn | Ca | Si | Na |
| Test 6 Aq Feed | 1725 | 1142 | 64 | 719 | 47 | 132 | 0 | 4403 |
| Test 6 Raff 1 | 1565 | 2 | 63 | 705 | 20 | 133 | 0 | 4312 |
| Test 6 Raff 3 | 1666 | 1 | 70 | 797 | 4 | 146 | 0 | 4875 |

Test 7.

For this test, the concentration of HCl used during the leaching phase was 4.8M, but with added CaCl₂ to bring the total chloride content of the liquor to 7.8M. This was done to see if the extraction behavior was more dependent on the acid content or the chloride content of the solution. As can be seen from the data in Table 5, the level of dissolved Ca in solution was quite high, and a large amount was extracted after the first contact. Compared to Test 5, a lesser amount of Ti was co-extracted with nearly the same extraction efficiency for Fe. It appears that the extraction is more dependent on the chloride content than the acidity. It is interesting to note that the solution Test 3, which contained 4.8 mol/L HCl, showed less stability and a greater tendency for precipitation than the solution with the same acid content but higher chloride content. The results are shown below.

TABLE 5
Test 7 Extraction Results.

| | Metal (ppm) | | | | | | | |
|---|---|---|---|---|---|---|---|---|
| Test | Ti | Fe | Al | Mg | Mn | Ca | Si | Na |
| Test 7 | 29071 | 4290 | 349 | 2194 | 221 | 63514 | — | 12463 |
| Aq | | | | | | | | |
| Feed | | | | | | | | |
| Test 7 | 28628 | 4 | 275 | 2130 | 120 | 46884 | 151 | 10793 |
| Raff 1 | | | | | | | | |
| Test 7 | 31618 | 6 | 297 | 2352 | 21 | 51869 | 132 | 11924 |
| Raff 3 | | | | | | | | |

Test 8.

The concentration of HCl used in Test 8 was 12M. Compared to Test 5, the increase in acid concentration does not appear to have changed the extraction performance by a significant degree. Nevertheless, the extraction efficiency of Fe remains quite high.

TABLE 6
Test 8 Extraction Results.

| | Metal (ppm) | | | | | | | |
|---|---|---|---|---|---|---|---|---|
| Test | Ti | Fe | Al | Mg | Mn | Ca | Si | Na |
| Test 8 Raff 1 | 28901 | 18 | 268 | 2220 | 116 | 369 | 86 | 1493 |
| Test 8 Raff 3 | 30244 | 2 | 302 | 2500 | 22 | 414 | 92 | 1683 |

Summary of Tests 1-8.

The efficiency of an extractant under specific conditions for a particular metal can be expressed as the extraction coefficient, Ec, which is defined as the concentration of that particular metal in the organic phase (C_{Morg}) divided by the concentration in the aqueous phase (C_{Maq}). It is also known as the distribution coefficient. The concentration of metal loaded into the organic phase was calculated taking into account the volume ratio of the organic to aqueous phases. The extraction coefficients for a one-stage solvent extraction with Alamine® 336 as the extractant are shown in Table 7.

TABLE 7
Extraction Coefficients For Tests 5-8.

| | Extraction Coefficient (E_{C}) of Metal | | | | | | | |
|---|---|---|---|---|---|---|---|---|
| Test | Ti | Fe | Al | Mg | Mn | Ca | Si | Na |
| Test 5 | 0.142 | 390 | 0.369 | 0.135 | 0.245 | 0.214 | — | 0.135 |
| Test 6 | 0.077 | 376 | 0.012 | 0.015 | 1.024 | — | — | 0.016 |
| Test 7 | 0.012 | 771 | 0.200 | 0.022 | 0.632 | 0.266 | — | 0.116 |
| Test 8 | 0.095 | 185 | 0.064 | 0.007 | 0.537 | 0.111 | — | 0.016 |

The selectivity of an extractant under specific conditions for a particular metal over another can be expressed as the selectivity index (S), which is simply the extraction coefficient of Metal A (E_{A}) divided by the extraction coefficient of Metal B (E_{B}) as expressed in Formula I:

$${S}_{A : B} = \frac{{E}_{A}}{{E}_{B}} \qquad ( I )$$

The selectivity for Fe over Ti for Tests 5-8 is shown Table 8.

TABLE 8
Selectivity for Fe over Ti.

| Test | Fe:Ti Selectivity |
|---|---|
| Test 5 | 2750 |
| Test 6 | 4900 |
| Test 7 | 66400 |
| Test 8 | 1950 |

While it may appear that the conditions in Test 7 led to the most efficient of extraction of Fe over Ti, the extraction coefficient for Fe in Test 4 would approach infinity since the iron left in the aqueous phase was negligible compared to the concentration in the organic phase.

While in most of the tests some co-extraction of titanium occurred, the amount co-extracted is relatively small when compared to the extraction of iron. Hydrolysis experiments have been conducted on leach solution treated with Alamine® 336 as described. The precipitated meta-titanic acid was calcined, and a TiO₂ pigment with an Fe content as low as 20 ppm has been produced.

### Example 2

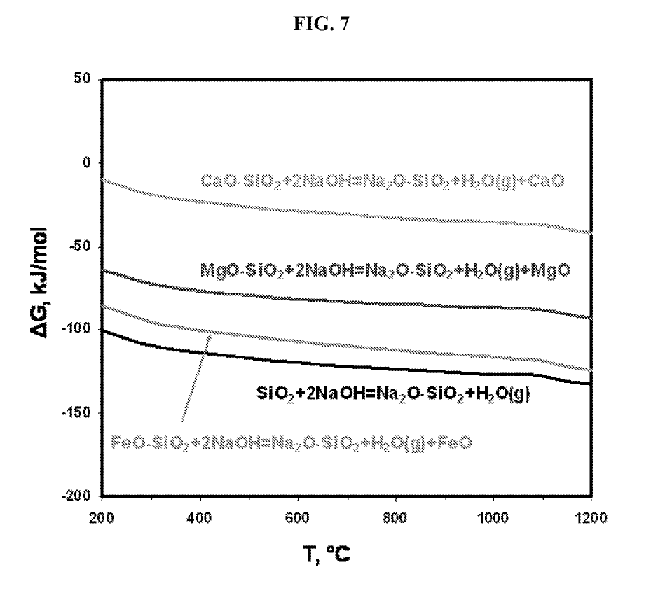

Reaction Of Sodium Hydroxide With Silicon Species. Silicon species in the TiO₂ slag exist in the forms of silica and various silicates such as MgO.SiO₂, CaO.SiO₂ and Fe.SiO₂. As such materials are difficult to leach in an alkaline solution, conversion of the materials during the atmosphere-controlled roasting with sodium hydroxide was done to illustrate that the roasting produced base soluble silicon-containing materials. Therefore, thermodynamic conversion calculations were performed using a commercial thermodynamic analysis software package, available from Outokumpu Research Oy (Outokumpu HSC Chemistry® for Windows, Version 5.1, 2002). The calculation results are shown in FIG. 7. Based on the fact that the Gibbs free energies of the reactions by which silica and those silicates react with sodium hydroxide to form sodium silicate are negative as shown in FIG. 7, it is expected that upon roasting with sodium hydroxide silicon species in the high-TiO₂ slag will be converted into sodium silicates.

The Na₂O—SiO₂ phase diagram suggests that the following sodium silicates: 2Na₂O.SiO₂, 3Na₂O.2SiO₂, Na₂O.SiO₂, Na₂O.2SiO₂ or 3Na₂O.8SiO₂, may form depending on the ratio of Na₂O to SiO₂. When there is a sufficient amount of NaOH during roasting, the formation of basic or neutral sodium silicates such as 2Na₂O.SiO₂, 3Na₂O.2SiO₂ or Na₂O.SiO₂ is thermodynamically more favorable than the formation of acidic sodium silicates such as Na₂O.2SiO₂ or 3Na₂O.8SiO₂. This situation is desired for subsequent leaching processes because basic and neutral silicates are soluble in aqueous solutions. However, if reactions of silicon species with sodium hydroxide during roasting are incomplete due to practical reasons such as insufficient length of time, low roasting temperature, insufficient amount of sodium hydroxide, and/or poor mixing of titania slag and NaOH, insoluble or difficult-to-leach species such as acidic sodium silicates and un-reacted silica and non-sodium silicates (MgO.SiO₂, CaO.SiO₂ and Fe.SiO₂) may persist after roasting.

The thermodynamic calculations illustrate that a higher roasting temperature may be beneficial to accelerate the conversion of silicon species into easy-to-leach sodium silicates, it is sufficient to choose a roasting temperature below the eutectic point of the Na₂O and SiO₂ system. Thus, in some embodiments, the roasting temperature is greater than about 700° C. In other embodiments, the roasting temperature if from about 700° C. to about 1000° C. In yet other embodiments, the roasting temperature is from about 700° C. to about 800° C. In some embodiments, a roasting temperature below about 800° C. is desired to prevent liquid formation of the roasted materials which can result in a condensed cake that is kinetically unfavorable for subsequent leaching processes.

### Example 3

Reaction Of Acidic Sodium Silicates And Silica During Alkaline Leaching. As mentioned above, basic and neutral sodium silicates are relatively easy-to-leach silicon species, since they are soluble even in water, while acidic sodium silicates and silica are difficult-to-leach species since they are insoluble in water. Based on the large negative value of the Gibbs free energy of the reaction between silica and saturated sodium hydroxide solution:

SiO₂+2NaOH [symbol] 2Na⁺+(SiO₃)²⁻+H₂O;ΔG=−88.8kJ/mol at 25° C.

it is clear that silica has a strong tendency to dissolve in strong alkaline solutions. The acidic sodium silicates such as Na₂O.2SiO₂ or 3Na₂O.8SiO₂ are also expected to have similar tendency to dissolve into alkaline solutions, though the required thermodynamic data for those silicates are not available. Therefore, it is expected that acidic sodium silicates and silica will be leachable in alkaline solutions.

### EQUIVALENTS

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

For the purposes of this disclosure and unless otherwise specified, “a” or “an” means “one or more”.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A process comprising:
roasting a TiO₂-containing material in the presence of an alkaline material to form a roasted product;
leaching the roasted product with an acidic solution to form a leach liquor;
extracting the leach liquor with an extractant to form a raffinate comprising Ti⁴⁺,
hydrolyzing the Ti⁴⁺ to form a hydrolyzed material comprising H₂TiO₃;
calcining the hydrolyzed material; and
recovering a TiO₂ product.

2. The process of claim 1, wherein the extractant comprises an alkyl phosphoric acid, an alkyl phosphonic acid, an alkyl phosphinic acid, a thioalkyl phosphinic acid, a phosphate, a phosphine oxide, a primary amine, a second amine, a tertiary amine, a quaternary ammonium salt, or an ion exchange resin.

3. The process of claim 1, wherein the extractant comprises di(2-ethylhexyl)phosphoric acid; 2-ethylhexyl phosphonic acid mono-2-ethylhexyl phosphoric ester; di-2,4,4-trimethylpentyl phosphinic acid; di-2,4,4-trimethylpentyl monothiophosphinic acid; di-2,4,4-trimethylpentyl dithiophosphinic acid; a phosphate of formula (O)P(OR¹)₃; a phosphine oxide of formula (O)PR²₃ or (O)PR³₂R⁴; trioctyl amine; or trioctyl methyl ammonium chloride; quarternary amine; wherein R¹, R², R³, and R⁴ are individually C4-C10 alkyl.

4. The process of claim 1, wherein the extractant comprises a tertiary amine which is a trialkylamine and each alkyl group of the trialkylamine is independently a C₆-C₁₈ alkyl.

5. The process of claim 4, wherein each alkyl group of the trialkylamine is independently a C₈-C₁₂ alkyl.

6. The process of claim 1, wherein the extractant comprises a trioctyl/decyl amine.

7. The process of claim 1, wherein the TiO₂-containing material is synthetic rutile, mineral rutile, or TiO₂ slag.

8. The process of claim 1, wherein the alkaline material is an alkaline hydroxide, an alkaline oxide, or a mixture of any two or more thereof.

9. The process of claim 1, wherein the alkaline material comprises sodium hydroxide, potassium hydroxide, sodium oxide, potassium oxide, or a mixture of any two or more thereof.

10. The process of claim 1, wherein the acidic solution comprises chloride content.

11. The process of claim 1, wherein the acidic solution comprises HCl, CaCl₂, NaCl or a mixture thereof.

12. The process of claim 1, wherein the roasting is carried out a temperature of at least about 500° C.

13. The process of claim 1, wherein the roasted product comprises one or more of Na₂Fe₂TiO₆ and Na₂TiO₃; and one or more impurities.

14. The process of claim 1, wherein the calcining is conducted at a temperature from about 500° C. to about 1000° C.

15. The process of claim 1, wherein the calcining is conducted at a temperature of about 600° C.

16. The process of claim 1, wherein the TiO₂ product comprises pigment-grade TiO₂.

17. The TiO₂ product prepared by the process of claim 1.

18. The TiO₂ product of claim 17 that is anatase TiO₂.

19. The TiO₂ product of claim 17 containing less than 50 ppm of Fe.
